(19) United States
(12) Patent Application Publication
(10) Pub. No.: US 2009/0127064 A1
(43) Pub. Date: May 21, 2009

(54) MACHINE FOR DISPENSING PAID-IN-CASH PRODUCTS AND/OR SERVICES

(75) Inventors: Bruno Marquet, Besancon (FR); Frederic Haustrate, Gennes (FR)

Correspondence Address: YOUNG & THOMPSON, 209 Madison Street, Suite 500, ALEXANDRIA, VA, 22314, US

(73) Assignee: Parkeon, Paris (FR)

(21) Appl. No.: 11/993,970

(22) PCT Filed: Jun. 26, 2006
(86) PCT No.: PCT/FR2006/001471

§ 371 Date: Nov. 26, 2008

(30) Foreign Application Priority Data
Jun. 27, 2005 (FR) 0551781

(51) Int. Cl. G07F 7/04

(52) U.S. Cl. 194/206

(57) ABSTRACT

A machine for dispensing paid in cash products and/or services includes a banknote reader and a removable receiver which are placed in a first compartment, wherein the removable receiver is held, in the operating position thereof, in the first compartment by locking elements in such a way that it communicates with the output of the banknote reader for receiving and storing processed banknotes. The machine includes a second collecting compartment which is accessible from the outside of the machine by opening an access flap which is connected to the second compartment and movable between the closed position of the second compartment and an open position, wherein the open position of the access flap automatically controls the receiver unlocking elements in such a way that the receiver is transferred from the first compartment to the second compartment by the internal connection channel of the machine.

This invention relates to the field of machines for the distribution of paid-in-cash products and/or services, and more particularly relates to the problem of the secure collection of banknotes present in these machines.

Especially in the United States, many machines for the distribution of products and/or services are equipped with means for payment by banknotes, generally associated with other possible means of payment such as payment using coin and/or credit cards and/or prepaid cards. By way of non-restrictive examples, payment in cash is currently available in the case of:
drinks distributors,
product distributors,
ticket distributors,
parking machines of the timer type, etc.

As these machines are intended to be located in public places they are particularly vulnerable to acts of vandalism. Thus special protection must be provided in order to render the storage of banknotes secure prior to collection.

Furthermore, access to the interior of the machine must be permitted to maintenance agents if repairs to the banknote reader or other components of the machine are required, while at the same time preventing these maintenance agents from gaining access to the banknotes.

Finally, specific protective measures must be applied to render the operations of collecting banknotes by collecting agents secure. Thus the collection of banknotes should in the main comply with the following two requirements:
firstly, collection must be easy and quick for collecting agents, in particular to reduce the time during which theft could be committed by another person at the time when the cash is being transferred,
secondly, any attempts at fraud by the collecting agents themselves must be prevented.

Thus machines accepting payment by banknotes are generally fitted with a removable receiver for the storage of banknotes which have been previously inserted by users and processed in a banknote reader. In this case the collection operation comprises recovering the removable receiver containing the banknotes from the machine and replacing it by an empty receiver.

Nowadays machines fitted with removable banknote receivers are constructed in two main forms:

In a first known form, the banknotes receiver is kept locked within the machine, attached to the rear of the banknote reader, while being independent of it. After processing by the reader the banknotes are stored in the receiver by gravity. A collecting agent can collect the receiver without passing through the compartment referred to as the maintenance compartment which comprises various components such as the reader. However, a maintenance agent can very easily remove the reader and then gain access to the contents of the receiver. Furthermore, in such a form of construction the collecting agent must carry out various successive operations (identification by mechanical or electronic key, followed by opening an access flap, unlocking the means holding the receiver, replacing the full receiver by an empty receiver, with a further operation of locking the empty receiver in the machine, and finally closing the access flap).

In a second known form, the banknotes receiver is kept locked within the machine directly to the rear of the banknote reader. After processing by the reader the banknotes are stored in the receiver by compression. As in the preceding form, too many operations are required for collection. Furthermore, in this second form access has to be gained to the reader in order to unlock the receiver. Thus undesirable access to the receiver is also provided to maintenance agents.

The object of this invention is to overcome the disadvantages of the aforesaid forms of construction by providing a new form for a paid-in-cash machine in which:
the number of operations required for collection and replacement by an empty receiver is advantageously reduced,
the operations of maintaining the reader and collecting the receiver are separated.

This object is achieved according to the invention, which relates to a machine for the paid-in-cash distribution of products and/or services of the type comprising a banknote reader within a first compartment for processing banknotes inserted by user, the said first compartment being capable of receiving a removable receiver in normal operation of the machine which when in its position of use is intended to be held in the first compartment by locking means associated with an outlet from the reader in order to receive and store the processed banknotes,

characterised in that it further comprises:
a second compartment known as a collecting compartment, which is separate from the first compartment and can be accessed from the exterior of the machine by opening an access flap which is attached to the second compartment and able to move between a position in which the second compartment is closed and a position in which it is open, and
control means designed to act together with the means operating the unlocking means when the said access flap is moved from its closed position to its open position to automatically control unlocking of the receiver, followed by transfer of the receiver from the first compartment to the second compartment via a connection channel within the machine.

In a particularly advantageous embodiment the first compartment is placed upon the second compartment, and the connecting channel comprises an opening between the first and the second compartments, the opening being dimensioned to permit the said transfer of the removable receiver through the action of gravity.

The invention, together with the advantages which it procures, will be better understood from the following description of a non-restrictive embodiment with reference to the appended figures in which:

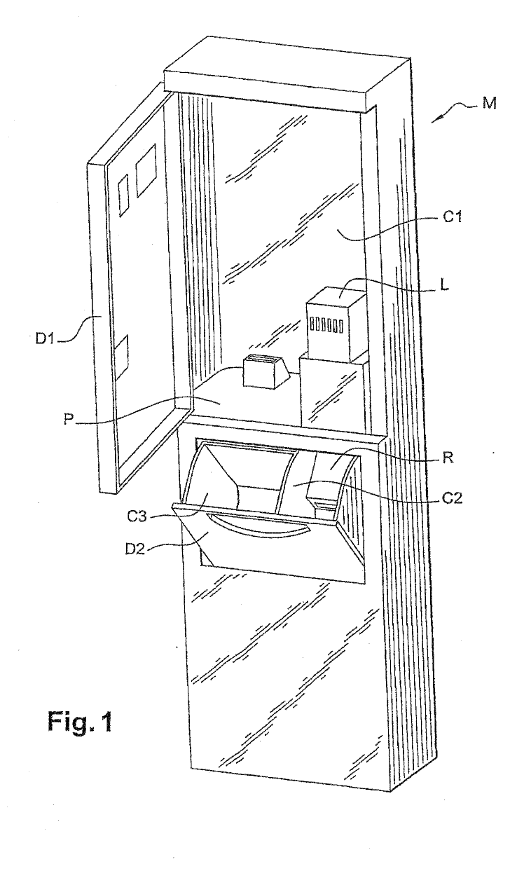

FIG. 1 illustrates, by way of example, a parking meter equipped with both a system for payment using coin and a system for payment using banknotes illustrating the invention,

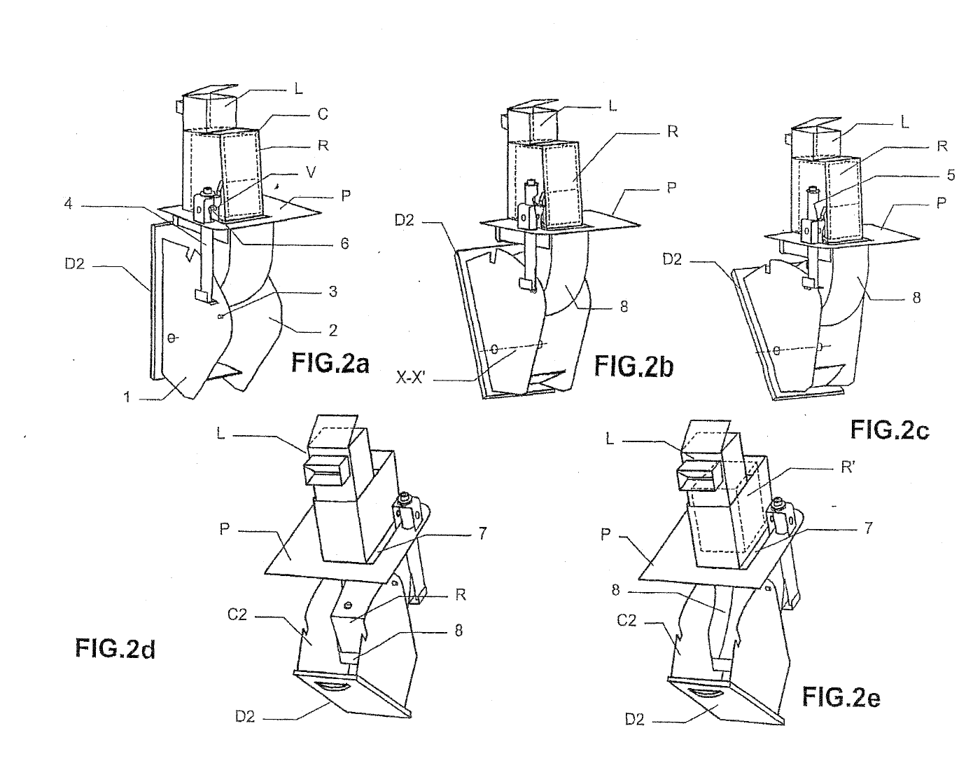

FIGS. 2a to 2e illustrate the different stages in an operation of collecting a banknote receiver and then replacing it by an empty receiver for a machine of the parking meter type in FIG. 1 fitted only with a system for payment using banknotes.

FIG. 1 illustrates a machine for the distribution of products and/or services, here a parking meter delivering a parking permit against payment either in coin or in banknotes, it being understood that this invention only relates to the aspect of payment using banknotes.

Parking meter M in FIG. 1 takes the form of a column having at least two compartments:
an upper compartment C1 referred to as the maintenance compartment which contains the components necessary for operation of the parking meter, including a banknote reader L which can process the banknotes inserted by a user, and
a compartment C2 which in the preferred example is located beneath compartment C1, and is intended specifically for collection of the banknotes.

In FIG. 1 a third compartment C3 is also shown, this compartment C3 being used for the collection of coin.

As can be seen in FIG. 2a, first compartment C1 can in the context of normal operation of the machine receive a removable receiver R which is intended to be held in first compartment C1 in a position corresponding to an outlet (not shown) from reader L. Thus banknotes inserted by one or more successive users are processed by the reader and then stored in receiver R either by gravity or by compression. The receiver is held in this position, known as the position of use, by locking means. The locking means are not illustrated as such, but FIG. 2a shows unlocking means V included in receiver R, the operation of which makes it possible to unlock the receiver. The locking means are located on the receiver itself, and make it possible for the locked receiver to be held directly against reader L. Other possibilities may nevertheless be envisaged, such as providing for the receiver to be held on other parts of compartment C1. Such removable receivers R comprising locking means are already known and will not be described in further detail in this description. For preference locking means comprising a system referred to as a “once only” system are selected, through which the removable receiver can only be fitted and locked in its position of use in the machine after it has been emptied of its contents by an authorised person.

As may be seen in the various figures, and according to a first aspect of the invention, second compartment C2 referred to as the collection compartment can be accessed from the exterior of the machine by opening an access flap D2 which is attached to second compartment C2 and moves between a position in which second compartment C2 is closed and a position in which it is open.

The parking meter also comprises locking means (not shown) for access flap D2, and (mechanical or electronic) identification means to permit unlocking of access flap D2 to second compartment C2.

According to a second aspect of the invention the movement of opening access flap D2 is associated with automatic unlocking of the receiver followed by transfer of the same, which is again automatic, from maintenance compartment C1 to collection compartment C2.

In order to do this machine M has according to the invention control means which act together with means activating the means V for unlocking the receiver during movement of the said access flap D2 from its closed position to its open position to automatically command unlocking of receiver R, followed by transfer of the receiver from first compartment C1 to second compartment C2 by a connection channel within the machine.

In the preferred embodiment described, access flap D2 and second compartment C2 can move by pivoting about an axis X-X′ (see FIG. 2b) which is substantially horizontal. As may be seen in the various figures, second compartment C2 is bounded by access flap D2 and by two side walls 1, 2 which extend perpendicular to pivot axis X-X′. The aforesaid control means comprise a pin 3 on one of the side walls (here wall 1), pin 3 extending outwards from second compartment C2.

The aforesaid activating means which are designed to act together with pin 3 in themselves comprise a rod 4 which can move vertically, extending parallel to side wall 1 bearing pin 3. The upper extremity of rod 4 enters within first compartment C1. The upper extremity of rod 4 also comprises a cam profile 5, which can more easily be seen in FIG. 2c. The activating means also comprise a finger 6 for operating unlocking means V, which can move within the first compartment in a substantially horizontal direction, a free extremity of the finger acting together with the cam profile (see FIG. 2a).

Starting from the starting position in FIG. 2a in which the access flap is in the closed position and the receiver is locked to the rear of reader L, it will be seen that pin 3 does not engage rod 4. Operating finger 6 is in a concavity in the cam profile so that it does not act on unlocking means V.

When a collecting agent causes flap D2 to tilt towards its open position about pivot axis X-X′, pin 3 engages the bottom extremity of rod 4 (see FIG. 2b). As flap D2 continues to tilt pin 3 causes rod 4 to move upwards and as a consequence causes movement of the cam profile and subsequently finger 6 controlling unlocking of the receiver (see FIG. 2c).

Once receiver R has been unlocked it can be transferred from first compartment C1 to second compartment C2. In the example illustrated first compartment C1 is located above second compartment C2, the two compartments being separated by a horizontal wall P. In this case it is sufficient to provide an opening 7 between the first and second compartments in wall P separating the two compartments as the connection channel, this opening being dimensioned to permit removable receiver R to be transferred merely through the action of gravity. Nevertheless, in the preferred embodiment illustrated in the Figures, the connection channel also comprises an inclined descent ramp 8 located between opening 7 and second compartment C2. The main purpose of this descent ramp is to slow the fall of receiver R, and thus avoid damaging it. Once transfer has been effected, receiver R lies in the position shown in FIG. 2d or FIG. 1. The collecting agent only has to recover receiver R and replace it by a new empty receiver R′. This replacement operation is also made easier by descent ramp 8 which is advantageously dimensioned to accept manual guidance of empty removable receiver R′ from second collection compartment C2 towards its operating position locked within first compartment C1 (see FIG. 2e showing second receiver R′ in the locked position).

Thus, through the invention the operation of collecting and replacing the banknote receiver only requires three operations on the part of the collecting agent:
opening of access flap D2, after prior identification,
removal of full banknote receiver R,
fitting a new empty banknote receiver R′ and closing the access flap.

This brings about a saving of time in the collection operation while very substantially improving its ergonomics.

Furthermore, as can be seen in FIG. 1, machine M also comprises a secure access flap D1 to first compartment C1 which is separate from access flap D2. The level of security is increased by separating the collection operation from the maintenance operation. More specifically, an agent responsible for maintenance only has access to compartment C1, and cannot gain access to receiver R because the latter is locked behind it. Security can be further increased by providing a protective cover C (see FIG. 2a) enclosing receiver R and preventing all access to the receiver by a maintenance agent. A collection agent in turn only has access to the collection compartment.

Although the invention has been described through a preferred embodiment, other embodiments are possible without going beyond the scope of this invention. In particular:
the access flap attached to compartment C2 has been described as moving by pivoting about a horizontal axis X-X′. Of course another type of movement, for example horizontal movement, could be envisaged, of course adapting the control means and the operating means so that opening bilateral movement of the flap also automatically controls unlocking of the receiver.
transfer of the receiver by gravity (or by a chute) in itself constitutes a preferred embodiment because it is simple and cheap to implement. Nevertheless it could be envisaged that compartments C1 and C2 are not positioned one above the other, in which case specific transfer means, which may be motor-driven, would have to be provided to ensure transfer of receiver R to collection compartment C2 once it had been unlocked.

1-9. (canceled)

10. A machine for the paid-in-cash distribution of products and/or services of the type comprising, within a first compartment, a banknote reader for the processing of banknotes inserted by a user, the said first compartment being capable in normal operation of the machine to receive a removable receiver which is intended to be held in its position of use by locking means in the said first compartment corresponding to an outlet from the reader to receive and store processed banknotes,
the machine further comprising:
a second compartment referred to as a collecting compartment, which is separate from the first compartment and can be accessed from the exterior of the machine by opening an access flap which is attached to the second compartment and able to move between a position in which the second compartment is closed and a position in which it is open, and
control means designed to act together with the means operating the unlocking means when the said access flap is moved from its closed position to its open position to automatically control unlocking of the receiver, followed by transfer of the receiver from the first compartment to the second compartment via a connection channel within the machine.

11. A machine according to claim 10, wherein the first compartment is placed upon the second compartment, and the connecting channel comprises an opening between the first and the second compartments, the opening being dimensioned to permit the said transfer of the moving receiver through the action of gravity.

12. A machine according to claim 11, wherein the said connection channel further comprises an inclined descent ramp placed between the said opening and the second compartment to slow transfer of the receiver by gravity.

13. A machine according to claim 12, wherein the said descent ramp is dimensioned to accept manual guidance of an empty removable receiver from the second collection compartment to its operating position locked within the first compartment.

14. A machine according to claim 11, wherein the said access flap and the second compartment can move by pivoting about a substantially horizontal axis.

15. A machine according to claim 14, wherein the second compartment being delimited by the said access flap and by two side walls extending perpendicularly to the pivot axis, the said control means comprise a pin, on one of the side walls projecting outwards from the second compartment and the said operating means comprise:
a rod which can move vertically, extending parallel to the side wall bearing the pin the upper extremity of which penetrates within the first compartment, the said upper extremity further comprising a cam profile,
a finger operating on unlocking means which can move in a substantially horizontal direction in the first compartment, a free extremity of the finger acting together with the cam profile,
and wherein the rod is pushed upward by the said pin when the access flap pivots, causing upward movement of the cam profile and movement of the operating finger controlling unlocking of the receiver.

16. A machine according to claim 10, wherein the means for locking the removable receiver comprise a system referred to as a “once only” system through which the removable receiver can only be fitted back in place in the machine after it has been emptied of the banknotes which it contains.

17. A machine according to claim 10, further comprising means for locking the access flap, and identification means to authorize unlocking of the access flap from the second compartment.

18. A machine according to claim 10, further comprising a secure access door to the first compartment, which is separate from the access flap.

19. A machine according to claim 10, wherein the said access flap and the second compartment can move by pivoting about a substantially horizontal axis.
